(19) United States
(12) Patent Application Publication
(10) Pub. No.: US 2022/0349569 A1
(43) Pub. Date: Nov. 3, 2022

(54) WATER FLOATING-TYPE LIGHT FOUNTAIN

(71) Applicant: Guangdong Minglun Optoelectronics Technology Co., Ltd., Dongguan (CN)

(72) Inventor: Yiqun Xu, Dongguan (CN)

(21) Appl. No.: 17/812,760

(22) Filed: Jul. 15, 2022

(30) Foreign Application Priority Data
Jun. 23, 2022 (CN) 202210721263.6

(51) Int. Cl. F21V 33/00; F21V 19/00; F21S 9/03; B05B 17/08

(52) U.S. Cl. CPC F21V 33/00; F21V 19/003; F21S 9/037; B05B 17/08

(57) ABSTRACT

A water floating-type light fountain includes a light-transmitting casing, a light-emitting assembly, and a water-spraying assembly. A mounting cavity is formed in the light-transmitting casing. The light-transmitting casing includes an upper casing and a bottom casing that are integrally formed. A band-shaped light-emitting surface is formed on an outer side surface of the upper case. The light-emitting assembly includes a circuit board, and a first light source and a second light source arranged on the circuit board. The first light source is located at the front of the circuit board, and the second light source is located at the back. The water-spraying assembly includes a spray head and a water pipe. The upper casing and the bottom casing are integrally formed, which effectively improves the waterproof performance of the light-transmitting casing, avoids water seepage, and saves the cost, and improves the landscape lighting effect of the light fountain.

### FIELD OF THE INVENTION

The present invention relates to the technical field of aquatic fountain, and more particularly to a water floating-type light fountain.

### BACKGROUND OF THE INVENTION

The light fountain has a structure with a specific shape that sprays water or other liquids through a nozzle under a certain pressure. The certain pressure is generally provided by a water pump. After years of development, light fountains include music fountains, program-controlled fountains, music and program-controlled fountains, laser water curtain movies, and funny fountains. According to the installation method of fountains, the light fountains are divided into fixed fountains and water floating-type fountains. Water floating-type fountains, namely, are movable fountains that can float on water. At present, such water floating-type fountains are generally small fountains. The shell includes upper and lower shells. The lower shell contains electronic components, the upper shell is used for floating, and the upper shell and the lower shell are separated. In this way, the number of mould of the shell is increased. Furthermore, it is necessary to provide a sealing structure between the upper shell and the lower shell. Such an arrangement increases production and assembly costs, and it is also prone to water leaks during use.

### SUMMARY OF THE INVENTION

One objective of the present invention is to provide a water floating-type light fountain with an integrated casing and landscape lighting function.

To achieve the above-mentioned objective, a light fountain is provided, which includes a light-transmitting casing, a light-emitting assembly, and a water-spraying assembly. The light-transmitting casing can float on water. A mounting cavity is formed in the light-transmitting casing. The light-transmitting casing includes an upper casing and a bottom casing that are integrally formed, and diameter of the upper casing being larger than diameter of the bottom casing. A hollow annular cavity is formed between a top surface and a bottom surface of the upper casing, so that a band-shaped light-emitting surface is formed on an outer side surface of the upper case. The top surface of the upper casing is further provided with an opening communicating with the mounting cavity. The light-emitting assembly includes a circuit board, and a first light source and a second light source arranged on the circuit board. The circuit board is disposed in the opening, the first light source is located at the front of the circuit board facing the opening, and the second light source is located at the back of the circuit board. The opening is also provided with a transparent cover plate above the circuit board, and the cover plate is sealedly connected with the upper casing. The water-spraying assembly includes a spray head and a water pipe. The spray head is arranged above the cover plate. One end of the water pipe is connected to the spray head, and the other end of the water pipe passes through the mounting cavity of the light-transmitting casing.

In comparison with the prior art, a light fountain in the present application can float on water and has a landscape lighting effect. The light fountain includes a light-transmitting casing, a light-emitting assembly and a water-spraying assembly. The upper casing and the bottom casing forming the light-transmitting casing are integrally formed, which effectively improves the waterproof performance of the light-transmitting casing, avoids water seepage into the light-transmitting casing, and saves the cost of mold opening and assembly. Furthermore, since the front and back sides of the circuit board are respectively provided with light sources, therefore, light can be projected upside the light-transmitting casing to illuminate the sprayed water column, and the light-emitting surface on the upper casing can emit light towards the side, thereby improving the landscape lighting effect of the light fountain.

Preferably, the bottom casing is provided with an accommodating groove which is open toward a bottom surface of the bottom casing. The accommodating groove is provided with a through hole that communicates with the mounting cavity for the water pipe to pass through. The through hole is tightly matched with the water pipe. The water-spraying assembly further includes a water pump disposed in the accommodating groove, and the water pipe is connected to the water pump.

Preferably, a filter plate is provided at a mouth of the accommodating groove.

Preferably, the mounting cavity of the light-transmitting casing is provided with a rechargeable power source that is electrically connected to the circuit board and the water pump.

Preferably, the water pump is provided with two exposed electrode contacts for controlling start/stop of the water pump, which are a cathode contact and an anode contact respectively.

Preferably, a solar panel is disposed above the cover plate in a sealed connection therewith, the solar panel is electrically connected to the rechargeable power source, and the solar panel is provided with a mounting hole for the spray head to pass through and a plurality of light-transmitting holes around the mounting hole.

Preferably, the first light source on the circuit board is directly opposite to the light-transmitting holes on the solar panel.

Preferably, the water pipe is fixed on the cover plate to form a whole structure with the cover plate.

Preferably, a sealing gasket is provided between the cover plate and the upper casing.

Preferably, a transition surface between the upper casing and the bottom casing is arc-shaped.

### BRIEF DESCRIPTION OF THE DRAWINGS

The accompanying drawings facilitate an understanding of the various embodiments of this invention. In such drawings:

FIG. 1 is a perspective view of a light fountain viewed from the front thereof according to one embodiment of the present invention;

FIG. 2 is a perspective view of the light fountain in FIG. 1 viewed from the back thereof;

FIG. 3 is a side view of the light fountain in FIG. 1;

FIG. 4 is an exploded view of the light fountain in FIG. 1;

FIG. 5 is a longitudinal sectional view of a light-transmitting casing in FIG. 1;

FIG. 6 is a perspective view of the light fountain according to another embodiment of the present invention viewed from the back thereof; and

FIG. 7 is a perspective view of a water pump.

### DETAILED DESCRIPTION OF ILLUSTRATED EMBODIMENTS

A distinct and full description of the technical solution of the present invention will follow by combining with the accompanying drawings.

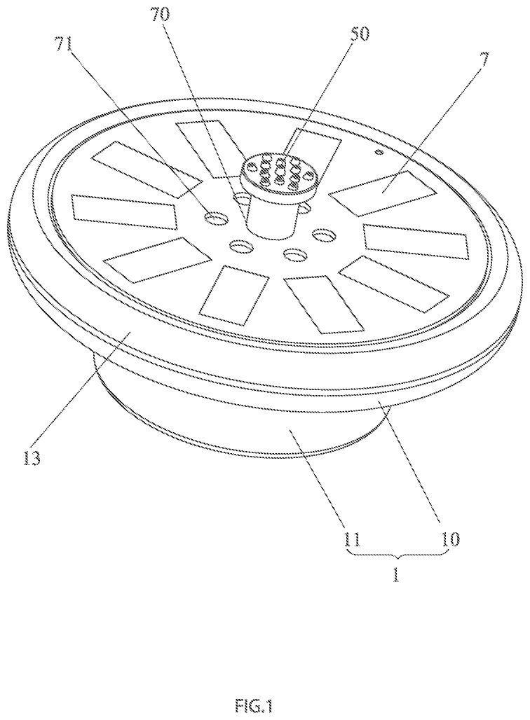

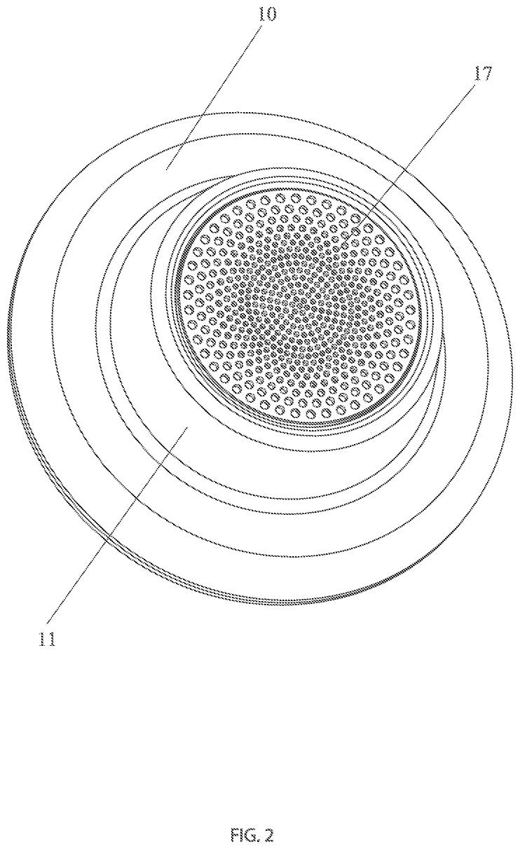

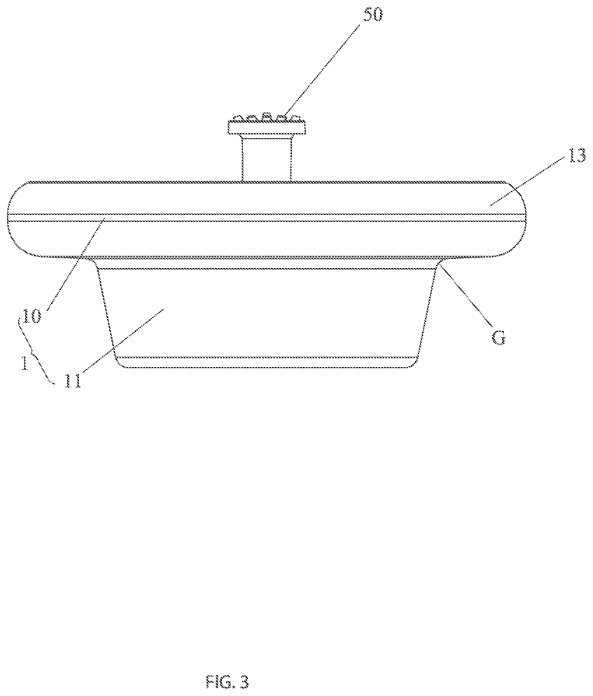

As shown in FIGS. 1 to 5, a light fountain according to an embodiment of the present application can float on water and has a landscape lighting effect. The light fountain includes a light-transmitting casing 1, a light-emitting assembly and a water-spraying assembly. The light-transmitting casing 1 can float on water, and a mounting cavity 100 for mounting the light-emitting assembly and the water-spraying assembly is formed in the light-transmitting casing 1.

Specifically, in this embodiment, the light-transmitting casing 1 is a lightweight plastic structure, which includes an upper casing 10 and a bottom casing 11 that are integrally formed. The diameter of the upper casing 10 is larger than the diameter of the bottom casing 11, so that the light fountain has a hat-like structure as a whole. A hollow annular cavity 12 is formed between a top surface and a bottom surface of the upper casing 10, and a band-shaped light-emitting surface 13 is formed on an outer side surface of the upper case 10. Preferably, a transition surface G between the upper casing 10 and the bottom casing 11 is arc-shaped, which is not only beautiful, but also increase toughness and service life of the light-transmitting casing 1.

Specifically, the top surface of the upper casing 10 is also provided with an opening 14 communicating with the mounting cavity 100. The light-emitting assembly includes a circuit board 20, and a first light source 21 and a second light source 22 arranged on the circuit board 20. The circuit board 20 is disposed in the opening 14. The first light source 21 is located at the front of the circuit board 20 facing the opening 14. The second light source 22 is located at the back of the circuit board 20. The opening 14 is also provided with a transparent cover plate 3 covering an upper side of the circuit board 20. The cover plate 3 is sealedly connected with the upper casing 10. Specifically, a sealing gasket 4 is provided between the cover plate 3 and the upper casing 10. The water-spraying assembly includes a spray head 50 and a water pipe 51. The spray head 50 is arranged above the cover plate 3. One end of the water pipe 51 is connected to the spray head 50, and the other end of the water pipe 51 passes through the mounting cavity 100 of the light-transmitting casing 1.

In this embodiment, the light fountain floats on the water when in use, and the light fountain can be moved to any position as required. Secondly, the upper casing 10 and the bottom casing 11 of the light-transmitting casing 1 are formed into a whole structure, thereby effectively improving the waterproof performance of the light-transmitting casing 1, avoiding water seepage into the light-transmitting casing 1, and saving the cost of mold opening and assembly. In addition, the light-transmitting casing 1 having the whole structure has good anti-impact performance, and corrosion resistance. Furthermore, since the front and back sides of the circuit board 20 are respectively provided with light sources. Therefore, when in use, the light emitted by the first light source 21 on the front of the circuit board 20 passes through the cover plate 3 and is projected onto a water column sprayed from the spray head 50, and the light emitted by the second light source 22 on the back of the circuit board 20 is projected onto on the light-emitting surface 13 of the upper casing 10. As a result, the upper casing 10 forms a strip-shaped light source surrounding the water column, thereby improving the landscape lighting effect of the light fountain.

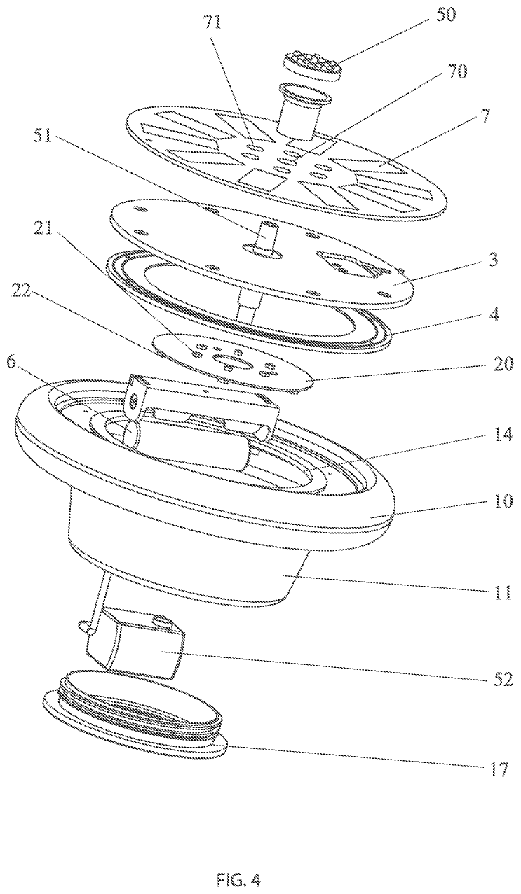

Optionally, as shown in FIG. 4, the water pipe 51 is fixed on the cover plate 3 to form a whole structure with the cover plate 3, so as to prevent water from entering the light-transmitting casing 1 through a connection point between the water pipe 51 and the cover plate 3, and to facilitate assembly.

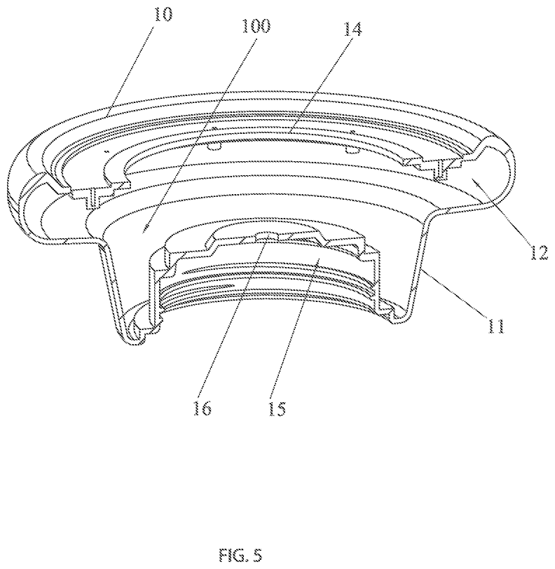

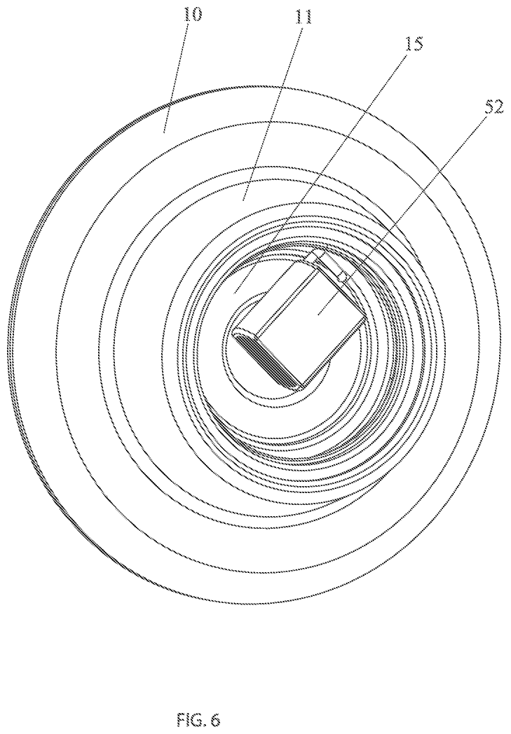

As shown in FIG. 5 and FIG. 6, the bottom casing 11 is further provided with an accommodating groove 15 which is open toward a bottom surface of the bottom casing 11. The accommodating groove 15 is provided with a through hole 16 that communicates with the mounting cavity 100 for the water pipe 51 to pass through. The through hole 16 is tightly matched with the water pipe 51, so as to prevent water from entering the mounting cavity 100 from the through hole 16 in the accommodating groove 15. The water-spraying assembly also includes a water pump 52 disposed in the accommodating groove 15, and the water pipe 51 is connected to the water pump 52. In this embodiment, the water pump 52 is arranged in the accommodating groove 15 at the bottom of the light-transmitting casing 1, which makes an overall structure of the light fountain more compact and makes the light fountain float more steadily. In addition, in order to prevent debris from entering the accommodating groove 15, affecting the work of the water pump 52, and blocking a water inlet of the spray head 50, a filter plate 17 is provided at a mouth of the accommodating groove 15.

Optionally, as shown in FIG. 4 and FIG. 6, the mounting cavity 100 of the light-transmitting casing 1 is provided with a rechargeable power source 6 that is electrically connected to the circuit board 20 and the water pump 52. By the rechargeable power source 6, the light fountain can be moved at any horizontal position without being limited by the extension length of an external power cord, and the safety is increased.

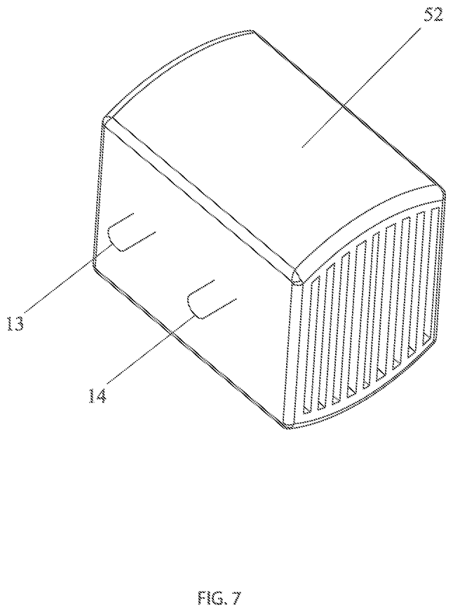

As shown in FIG. 7, the water pump 52 is provided with two exposed electrode contacts for controlling start/stop of the water pump 52, which are a cathode contact 53 and an anode contact 54 respectively. In this embodiment, the cathode contact 53 and the anode contact 54 act as an automatic switch for the water pump 52. When the light fountain is placed in the water, the cathode contact 53 and the anode contact 54 are electrically connected by means of the water, so the water pump 52 is energized and works. When the light fountain is moved out of the water, the cathode contact 53 and the anode contact 54 are disconnected due to the loss of the conductive medium, so that the power supply path of the water pump 52 is disconnected, and the water pump 52 automatically stops working. Therefore, through the cathode contact 53 and the anode contact 54, the water pump 52 in the light fountain can be automatically started or stopped, which is convenient to use and saves energy.

Referring to FIG. 4 again, a solar panel 7 is also disposed above the cover plate 3 in a sealed connection therewith. The solar panel 7 is electrically connected to the rechargeable power source 6. The solar panel 7 is provided with a mounting hole 70 for the spray head 50 to pass through and a plurality of light-transmitting holes 71 around the mounting hole 70, so that the light emitted by the first light source 21 can be projected around the spray head 50 through the light-transmitting holes 71. In this embodiment, through the solar panel 7, it can be omitted to replace the power source. Preferably, the first light source 21 on the circuit board 20 is directly opposite to the light-transmitting holes 71 on the solar panel 7.

While the invention has been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention.

What is claimed is:

1. A water floating-type light fountain, the light fountain comprising:
a light-transmitting casing which floats on water, a mounting cavity being formed in the light-transmitting casing, the light-transmitting casing comprising an upper casing and a bottom casing that are integrally formed, diameter of the upper casing being larger than diameter of the bottom casing, a hollow annular cavity being formed between a top surface and a bottom surface of the upper casing, so that a band-shaped light-emitting surface being formed on an outer side surface of the upper case, and the top surface of the upper casing being further provided with an opening communicating with the mounting cavity;
a light-emitting assembly comprising a circuit board, and a first light source and a second light source arranged on the circuit board, the circuit board being disposed in the opening, the first light source being located at the front of the circuit board facing the opening, the second light source being located at the back of the circuit board, the opening being also provided with a transparent cover plate above the circuit board, the cover plate being sealedly connected with the upper casing; and
a water-spraying assembly comprising a spray head and a water pipe, the spray head being arranged above the cover plate, one end of the water pipe being connected to the spray head, and the other end of the water pipe passing through the mounting cavity of the light-transmitting casing.

2. The light fountain according to claim 1, wherein the bottom casing is provided with an accommodating groove which is open toward a bottom surface of the bottom casing, the accommodating groove is provided with a through hole that communicates with the mounting cavity for the water pipe to pass through, the through hole is tightly matched with the water pipe, the water-spraying assembly further comprises a water pump disposed in the accommodating groove, and the water pipe is connected to the water pump.

3. The light fountain according to claim 2, wherein a filter plate is provided at a mouth of the accommodating groove.

4. The light fountain according to claim 2, wherein the mounting cavity of the light-transmitting casing is provided with a rechargeable power source that is electrically connected to the circuit board and the water pump.

5. The light fountain according to claim 4, wherein the water pump is provided with two exposed electrode contacts for controlling start/stop of the water pump, which are a cathode contact and an anode contact respectively.

6. The light fountain according to claim 4, wherein a solar panel is disposed above the cover plate in a sealed connection therewith, the solar panel is electrically connected to the rechargeable power source, and the solar panel is provided with a mounting hole for the spray head to pass through and a plurality of light-transmitting holes around the mounting hole.

7. The light fountain according to claim 6, wherein the first light source on the circuit board is directly opposite to the light-transmitting holes on the solar panel.

8. The light fountain according to claim 1, wherein the water pipe is fixed on the cover plate to form a whole structure with the cover plate.

9. The light fountain according to claim 1, wherein a sealing gasket is provided between the cover plate and the upper casing.

10. The light fountain according to claim 1, wherein a transition surface between the upper casing and the bottom casing is arc-shaped.
